(19) United States
(12) Patent Application Publication
(10) Pub. No.: US 2019/0369013 A1
(43) Pub. Date: Dec. 5, 2019

(54) METHOD AND APPARATUS FOR SPECTROSCOPIC ANALYSIS, IMPLEMENTING INFRARED AND FLUORESCENCE MULTICHANNEL PROCESSING OF SPECTRAL DATA

(71) Applicants: Inès Birlouez-Aragon, Ermont (FR); Pierre Lacotte, Béziers (FR); Abdelhaq Acharid, Arnouville (FR); Fatma Allouche, Aulnay-sous-Bois (FR); Jad Rizkallah, Khoder METN (LB)

(72) Inventors: Inès Birlouez-Aragon, Ermont (FR); Pierre Lacotte, Béziers (FR); Abdelhaq Acharid, Arnouville (FR); Fatma Allouche, Aulnay-sous-Bois (FR); Jad Rizkallah, Khoder METN (LB)

(73) Assignee: SPECTRALYS INNOVATION, Romainville (FR)

(21) Appl. No.: 16/073,750

(22) PCT Filed: Jan. 31, 2017
(86) PCT No.: PCT/EP2017/052046

§ 371 Date: Dec. 6, 2018

(30) Foreign Application Priority Data
Feb. 2, 2016 (FR) 1650830

(51) Int. Cl. G01N 21/3563; G01N 21/64

(52) U.S. Cl. CPC G01N 21/3563; G01N 2021/1736; G01N 2201/129; G01N 21/6486

(57) ABSTRACT

Method for analysing at least one sample, implementing a method for analysing spectroscopic data based on a multiway statistical model, characterised in that it comprises: a) the illumination of said or of each sample to be analysed by a first light source and by a second light source, said at least one second light source being separate from said first light source; b) the acquisition of fluorescence spectrums from said or from each sample, said fluorescence spectrums resulting from the illumination of said or of each sample by one or more light beams emitted by said first light source; c) the acquisition of transmittance and/or reflectance spectrums from said or from each sample, said transmittance and/or reflectance spectrums resulting from the illumination of said or of each sample by one or more light beams emitted by said second light source; d) the organisation of said fluorescence spectrums acquired into a first acquisition data cube; e) the organisation of said transmittance and/or reflectance spectrums into a second acquisition data cube; f) the amalgamation of acquisition data of said first cube and acquisition data of said second cube into a third amalgamated data cube; g) the decomposition of the amalgamated data from said third cube by applying said multiway statistical model; h) the determination of at least one indicator characterising said or each sample, from the data coming from applying said multiway statistical model to said amalgamated data. Device for the implementation of such a method.

The present invention is based on a method and a device for spectroscopic analysis. The invention more specifically relates to a method for analysing at least one sample by applying multiway statistic processing to a set of spectral data coming from different spectroscopic analysis techniques.

The invention can be applied, in particular, but not only, to the agribusiness industry, the pharmaceutical industry, or the environmental industry. In the agribusiness industry, it enables, for example, the study of the technological, nutritional and/or toxicological properties of a food product during the preparation thereof, or the farming, biological or technological methods to which said product is subjected. More generally, the invention can be applied to determining any quality indicator of a sample, and/or any parameter characterising a method to which said sample has been subjected.

To determine the parameters indicating the quality of a food product, referred to as quality parameters, it is known from spectroscopic analyses resorting to chemometric methods. In this context, absorption spectroscopy methods, in this including transmittance spectroscopy and/or reflectance spectroscopy, are based on numerous devices equipping agribusiness factories and sites for receiving raw farming materials. Absorption spectroscopy in the field of infrared (IR) and/or near infrared (NIR) enables, in particular, to evaluate the measurements of the content of food products in components of increased concentration such as proteins, fat, water content or total sugars.

Conventionally, methods known and used for absorption spectroscopy are based on methods for the statistical multivariate analysis of spectroscopic data. The multiway analysis is the natural extension from multivariate analysis when the data is multidimensional as in the case of fluorescence (excitation and emission matrices) and is thus based on the use of multiway statistical models such as “PARAFAC” (“Parallel Factor”) and “NPLS” (“N-ways Partial Least Squares regression”).

However, numerous industrial procedures today require a specific knowledge of the raw material constituting these samples, in particular to carry out detailed analyses of the technological, nutritional and/or toxicological properties of a given product. For example, it can be required to know various parameters such as the contamination level of these samples by adverse chemical molecules (acrylamide, mycotoxins, etc.), the structure of the proteins which condition the functionality thereof (denaturation rate, aggregate size, etc.), or the germination state of a grain (Hagberg falling number of wheat, potential germination of barley in the malthouse, etc.). To be measured precisely, these parameters require processing of the spectroscopy data over an electromagnetic spectrum field that is as wide as possible, including infrared, visible, and ultraviolet. Yet, the quality parameters determined using only absorption spectroscopy, generally applied in the infrared field, provide not very precise information on the samples analysed. For example, this type of spectroscopy does not enable to quantify the molecules present in the trace state (<0.5%), as is the case for mycotoxins or acrylamide.

A solution known from the state of the art to quantify more specifically the quality of the products analysed and to resort to a fluorescence technology. A sample subjected to a light beam with a determined wavelength, for example, in the visible (Vis) and/or ultraviolet (UV) field, emits, as a response, emission beams according to the components contained in this sample. Based on the measurement of these emission beams, it is possible to obtain the corresponding fluorescence spectrum, according to the wavelengths. Fluorescence spectroscopy thus enables to characterise trends such as the change in pH, the heating of food matrices as is the case for plant oils, or analysing contaminants or the characterisation of the growth of a plant and the germination of a grain. The information obtained also enables to evaluate different markers of technological quality of the sample(s) analysed.

Despite the sensitivity thereof, it is known that fluorescence spectroscopy does not enable to precisely determine the same quality parameters to which absorption spectroscopy enables access. In particular, absorption spectroscopy informs about the interatomic bonds, whereas fluorescence is interested in the molecular composition. For example, sugars can be characterised by the carbonyl intermolecular bond, quantifiable in infrared, but they are not fluorescent, and therefore not quantifiable by fluorescence. Proteins can possibly be visible by both technologies, but through different structures: the amide grouping for infrared and the aromatic cycle of amino acids, such as in particular, fluorescent tryptophan. Therefore, the fluorescence signals and the absorption signals emitted on the surface of a given sample should logically be used together, to determine a greater amount of information relating to the physico-chemical state of a sample, by illuminating it with light beams with wavelengths determined from the electromagnetic spectrum.

However, the joint processing of data coming from both these technologies, for example, absorption in the IR and NIR fields and fluorescence in the Vis and UV fields, today remains problematic, as it is limited by the effectiveness of the current analysis methods. Typically, the processing of data coming from the two different technologies is done separately. The results obtained from both types of spectroscopy does not therefore benefit from synergies and complementarities resulting from the joint use thereof. In addition, the handling and combination of the data acquired by two different spectroscopy technologies are subject to numerous technical constraints, limiting the performance of the associated analysis methods. Obtaining reduced variables obtained via the application of multivariate decomposition tools for each technology resolves a part of this complementarity but does not enable to precisely and reliably extract all the original and non-reduced spectral information. In addition, this information is not correlated, since it does not give the powerful advantage to the processing applied, given the overlapping caused by both technologies. This information is not complimentary either, since it does not enrich the information extracted. Finally, these approaches only best enable a classification or comparison of samples, whereas the quantification of indicators is a lot more interesting and useful for professionals. To benefit from both types of measurement, the producers, manufacturers and cooperatives are generally equipped with two different types of analysers, which represents potentially high staff, investment and logistics costs.

To overcome these difficulties or limits of utilisation of the different technologies, the invention aims to propose a method for analysing at least one sample implementing a method for analysing spectroscopic data based on a multiway statistical model, characterised in that it comprises:

a) the illuminating of said or of each sample to be analysed by a first light source and by a second light source, said at least one second light source being separate from said first light source;

b) the acquisition of fluorescence spectrums of said or of each sample, said fluorescence spectrums resulting from the illuminating of said or of each sample by one or more light beams emitted by said first light source;

c) the acquisition of transmittance and/or reflectance spectrums of said or of each sample, said transmittance and/or reflectance spectrums resulting from the illuminating of said or of each sample by one or more light beams emitted by said second light source;

d) the organisation of said fluorescence spectrums acquired in a first acquisition data cube;

e) the organisation of said transmittance and/or reflectance spectrums acquired in a second acquisition data cube;

f) the amalgamation of the acquisition data from said first cube and the acquisition data from said second cube into a third amalgamated data cube;

g) the decomposition of amalgamated data from said third cube by application of said multiway statistical model;

h) the determination of at least one indicator characterising said or each sample, from the data coming from the application of said multiway statistical model to said amalgamated data.

According to different additional characteristics which can be taken together or separately:
said first light source is a light beam source with respective illumination wavelengths.
said second light source is a continuous source.
said fluorescence spectrums are spectrums acquired over a spectral range of between 250 nm and 800 nm.
said transmittance and/or reflectance spectrums are spectrums acquired over a spectral range of between 400 nm and 2,500 nm, and preferably over a spectral range of between 400 nm and 1,100 nm.
the number of light beams emitted by the first light source is between one and eight, and preferably between two and five.
the fluorescence spectrums are fluorescence spectrums acquired in frontal mode.
said step d) also comprises a prior step of standardising said fluorescence spectrums and/or said transmittance and/or reflectance spectrums.
said multiway statistical model implemented is a Tucker type model.
said determination of an indicator characterising said or each sample is done by application of a calibration model connecting the decomposition data to said indicator.

The invention further aims to propose a device for analysing at least one sample for the implementation of a method according to the invention, characterised in that it comprises:
means for illuminating said or each sample to be analysed, said illumination means comprising a first light source and at least one second light source, said at least one second light source being separate from said first light source;
a first means for acquiring fluorescence spectrums of said or of each sample, said fluorescence spectrums resulting from the illuminating of said or of each sample by one or more lights emitted by said first light source;
a second means for acquiring transmittance and/or reflectance spectrums of said or of each sample, said transmittance and/or reflectance spectrums resulting from the illuminating of said or of each sample by one or more light beams emitted by said second light source; and
one or more processors configured to implement at least steps d) to h).

Other characteristics, details and advantages of the invention will emerge upon reading the description made in reference to the appended drawings given as an example and which represent, respectively:

FIG. 1, a principle diagram of an analysis device according to an embodiment of the invention;

FIG. 2, a diagram defining the organisation of the spectral data in acquisition data cubes;

FIGS. 3, 4 and 5, of the diagrams defining the organisation and the amalgamation of the acquisition data into at least one amalgamated data cube according to different embodiments.

A first step a) of a method according to the invention comprises the illuminating of a sample or of more samples by a plurality of light sources. FIG. 1 shows a simplified diagram of a device A for the implementation of a method according to the invention. Such as represented, a sample E is arranged on a support H. Said sample can be a solid, a powder, a liquid contained in a transparent container, etc. The support H can be transparent or partially transparent to light radiation.

The device A comprises a first light source S1 arranged on one side of said support H, and configured to light up E. Advantageously, said first light source is a source of excitation light radiation with respective illuminating wavelengths. Preferably, each one of said light sources emits a beam of monochromatic radiation with a different wavelength. According to the invention, the illuminating of E by the first light source enables to generate a fluorescence spectrum. The fluorescence spectroscopy consists of sending a light beam with a determined wavelength in the direction of a sample. This light beam typically has at least one wavelength in the visible (Vis) and/or ultraviolet (UV) field to cause an excitation of the components contained in this sample. The wavelengths characterising said light beams extend over a spectral range, typically of between 250 nm and 800 nm. For each excitation light beam corresponding to a wavelength λ_{excitation}, the sample considered emits a full spectrum, referred to as fluorescence spectrum, comprising a plurality of emission beams corresponding to several wavelengths λₑₘᵢₛₛᵢₒₙ. These beams generally comprise two contributions: one, with the same wavelength as the illumination beam, due to the elastic diffusion; the other, polychromatic, due to the fluorescence, the corresponding emission beams being characterised by a wavelength λₑₘᵢₛₛᵢₒₙ greater than λ_{excitation}. The fluorescence spectrums can also include auto-fluorescence spectrums or, in certain cases, fluorescence spectrums induced by marker added to the sample.

In a non-limitative way, said first light source can comprise one single monochromatic radiation source, a number of monochromatic radiation sources greater than two, or one or more polychromatic light sources generating illuminating beams of said first light source. Advantageously, the first light source comprises one or more light-emitting diodes. S1 can thus also include one or more laser sources if more significant intensities are required. As illustrated in FIG. 1, S1 can comprise another light source S12, even more generally several other light sources separate from S1. Preferably, but non-restrictively, said wavelengths of the light beams are between 250 nm and 800 nm. Generally, the excitation light beams can have wavelengths selected so as to cover the widest UV-visible spectrum as possible. According to the number of radiation sources, these excitation beams can roughly sample (several dozen wavelengths) and/or finely sample (several hundred wavelengths) a spectral range covering the infrared, visible and ultraviolet fields. Advantageously, the number of light beams emitted by the first light source is between one and eight, and preferably between two and five.

Advantageously, the fluorescence spectrums are fluorescence spectrums acquired in frontal mode. The specific use of a fluorescence in frontal mode has the advantage of being able to apply the method in real time. In addition, the acquisition of frontal fluorescence spectrums emitted by said or of each sample does not generate any analytical error connected to the preparation of the sample. The results obtained by the method according to the invention are therefore more precise and determined more quickly.

The device A also comprises a second light source S2 configured to illuminate the sample E. This illumination of E by the source S2 can be provided before or after the illumination of E by the source S1 such as detailed above. Advantageously, S2 is a continuous light source, for example, a polychromatic source such as a tungsten, halogen or halogen/tungsten lamp. The source S2 is configured to emit a continuous beam of which the wavelengths can be distributed over a wide spectral range of the electromagnetic spectrum. Advantageously, S1 is configured to illuminate the sample over a spectral range of between 400 and 2500 nm, and preferably between 400 nm and 1,100 nm. This spectral range can comprise, the visible, infrared and/or near infrared field. An illumination module MI can also be added to the source S2 to direct the beams emitted by S2 towards the sample E. These beams are absorbed by the sample, before being detected by the acquisition means MA, as detailed below.

According to the invention, the illumination of E by the source S2 enables to generate an absorption spectrum. These absorption signals can, in particular, include transmittance and/or reflectance signals. The absorption spectroscopy is based on the principle according to which any material subjected to an incident beam, for example, an infrared beam, can either reflect a part of these beams, or absorb a part of these beams, or transmit a part of these beams. More specifically, absorption spectroscopy is based on the property of the atomic bonds to absorb the light energy with a wavelength of interest.

It will be noted that the second light source can be arranged on the same side as the first light source with respect to the sample, or along any other direction. Advantageously, the first light source and the second light source are arranged along two different sides of the sample E and/or of the support H. Finally, the use of one single device, comprising for example one same measuring chamber and one single spectrometer configured to analyse a set of spectrums acquired in the ultraviolet, visible, infrared, and/or near infrared fields, enables to facilitate the consistency of data obtained over one same sample.

A second step b) and a third step c) of a method according to the invention comprises the acquisition of fluorescence and absorption spectrums of said or of each sample.

According to the invention, the set of fluorescence spectrums and absorption spectrums coming from the sample are captured by the acquisition means MA. Said means MA detect and measure any light beam emitted, reflected or transmitted by the sample, and resulting from an illumination of said sample. The means MA comprise, for example, one or more measuring stations, physically separate or not, and enabling to acquire the fluorescence spectrums and the absorption spectrums coming from the sample. Advantageously, the means MA are co-located in one single measuring station, and suitably arranged so as to receive optimally any type of radiation coming from the sample E. This facilitates the analysis of the same sample from the material making the method more effective, reducing the time necessary for the analysis, and enabling a better correlation of the spectroscopic data relating to the material.

The fluorescence signals and the absorption signals emitted by E are then transported by the intermediary of communication means MC to one or more processors P. Said communication means MC can comprise a wired connection, for example, of optical fibre type, Ethernet, PLC, even a wireless connection, for example of Wi-Fi or Bluetooth type, or any other type of connection which could vary according to the preferred material for the implementation of the invention. The processor(s) P can themselves comprise a device for processing the signal, a spectrometer configured to decompose the light beam emitted in the spectrum, or any other processing equipment adapted to the method. More generally, P includes the means for processing the data (for example, a computer suitably programmed) enabling to extract chemometric information from spectrums acquired by the device A. The signals are typically analysed by chemometric methods which enable to extract the information correlated at the quality parameters that are looked to be measured. These correlations are present in numerous food products and appear because of the development of the content thereof. For example, the intrinsic fluorescence from the natural components of a food (vitamins, proteins and other natural components, or components that are added, intentionally or not), as well as the reflectance thereof, can develop over time, whereas over the same time, new signals can appear because of the formation of new molecules. Said correlations therefore play an important role as part of the characterisation thereof by the spectroscopic analyses.

A fourth step d) and a fifth step e) of a method according to the invention comprises the organisation of the fluorescence spectrums acquired and the absorption spectrums acquired in a first cube and in a second cube of acquisition data, respectively.

Once the fluorescence, transmittance and/or reflectance spectrums are acquired for the sample(s) analysed, the data collected is organised into data cubes. By definition, said data cubes comprise several matrices referred to as “excitation/emission matrices” (EEM), said matrices being built to contain all the spectrums acquired over one sample. In particular, an EEM can be a two-way table, said table could be represented by a three-dimensional spectrum in the “Excitation×Emission×Intensity” form. For the specific case of an acquisition of one or more fluorescence spectrums, an acquisition data cube will typically comprise three dimensions, “Excitation×Emission×Sample”.

The modes of organising the spectral data into data cubes according to the invention are illustrated in FIG. 2. Organising the data acquired into data cubes will enable, in the following steps of the method, to apply multiway analysis methods that are a lot more powerful than multivariate decomposition tools.

During the acquisition of fluorescence data, the fluorescence measurements are organised in a three-dimensional data cube, “I×J×K”, referred to as first acquisition data cube C1, or “fluorescence cube”. Each one of said three dimensions corresponds to a given mode. The mode I of C1, comprising a number “i” of entries, is associated with the number of samples illuminated by the second light source during the step for acquiring fluorescence spectrums of said or of each sample. The mode J of C1, comprising a number “j” of entries, is associated with the number “j” of emission wavelengths, each one of these wavelengths corresponding to one of the components of the beams emitted by said sample or said samples after illumination of it or of those by the first light source. The mode K of C1, comprising a number “k” of entries, is associated with the number “k” of excitation wavelengths, each one of these wavelengths corresponding to a light beam used for illuminating the sample or the sample. The fluorescence data obtained is thus organised into a three-dimensional cube, these dimensions corresponding to the three modes, “Excitations×Emissions×Samples”.

During the acquisition of the absorption data, the absorption measurements are organised into a two-dimensional data cube, “I×L”, referred to second acquisition data cube C2, or “absorption cube”. Each one of said two dimensions corresponds to a given mode. The mode I of C2, comprising a number “i” of entries, is associated with the number of samples illuminated by the first light source during the step for acquiring transmittance and/or reflectance spectrums of said or of each sample. The mode L of C2, comprising a number “I” of entries, is associated with the number “I” of absorption wavelengths, each one of these wavelengths corresponding to one of the components of the beams emitted by said sample or of said samples after illumination of it or of those by the second light source. The fluorescence data obtained is thus organised into a two-dimensional cube, “I×L”, corresponding to the modes, “Emissions×Samples”.

A sixth step f) of a method according to the invention comprises the amalgamation of the data from the first cube and the data from the second cube within a third cube, referred to as amalgamated data.

Three modes for organising and amalgamating data are thus proposed. Such as defined, the first mode for organising data has the advantage of adhering to the physics of the data acquired. A significant technical effect of the first and of the third mode for organising the data defined below is that it preserves the linearity of the spectral data acquired separately by each one of the two spectroscopy techniques. These embodiments also enable to preserve the correlations between the absorption data and the fluorescence data during the amalgamation of the first data cube and of the second data cube. These correlations are significant, are they can include information connecting fluorescence spectrums in the ultraviolet/visible and the transmittance spectrums in the visible/near infrared for a given sample. This information is, for example: analyte concentrations, the physico-chemical structure, or the functionalities and the sensoriality of the product. This information can be particularly useful for defining the quality criteria specific for the sample analysed, and is difficult to access via the use of only absorption spectroscopy or only fluorescence spectroscopy.

Such as illustrated in FIG. 3, an embodiment according to the invention consists of joining the first acquisition data cube and the second acquisition data cube into one same third data cube C31, referred to as amalgamated data.

During the step 3.1, the cube C2 is transformed into a three-dimensional cube Ix Lx L, such that the cube I×L constitutes a diagonal plane of a cube I×L×L according to the modes L×L, of which the diagonal has a dimension equal to the diagonal formed by the elastic diffusion of the k^{th} source of the fluorescence cube. During the step 3.2, this cube I×L×L is concatenated with the cube C1 of dimensions I×J×K to form the cube C31. The other entries of the cube C31 are filled with values equal to zero. This concatenation is done so as to align the mode L with the modes J and K to constitute said cube C3 of amalgamated data. The cube C31 is, thus, a cube of dimensions I×(K+L)×(K+L), of which the upper-left part contains the fluorescence data in the form of a three-dimensional sub-cube, and of which one part of the diagonal plane contains the absorption data in the form of a diagonal sub-plane according to the modes (K+L)×(K+L).

This organisation of data has the advantage of adhering to the initial common modes of the cubes C1 and C2, since the mode L of C2 is aligned with the modes J and K of C1. Since these modes correspond respectively to the emission wavelengths and to the excitation wavelengths, the correlation between the data acquired by fluorescence spectroscopy and the data acquired by absorption spectroscopy is preserved.

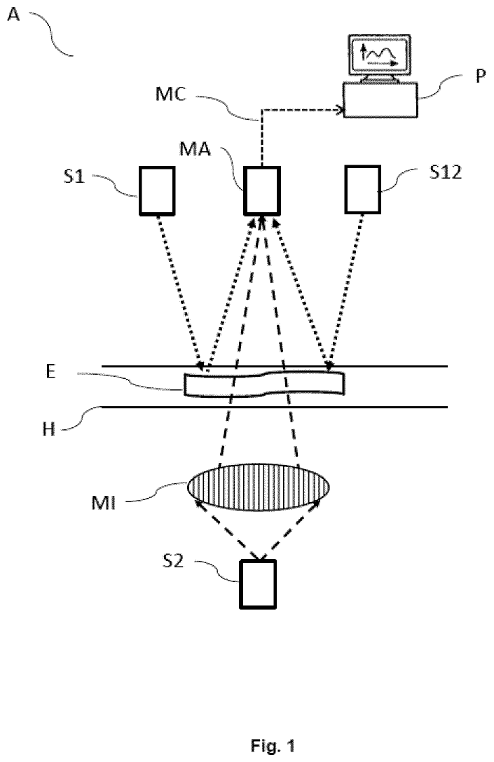

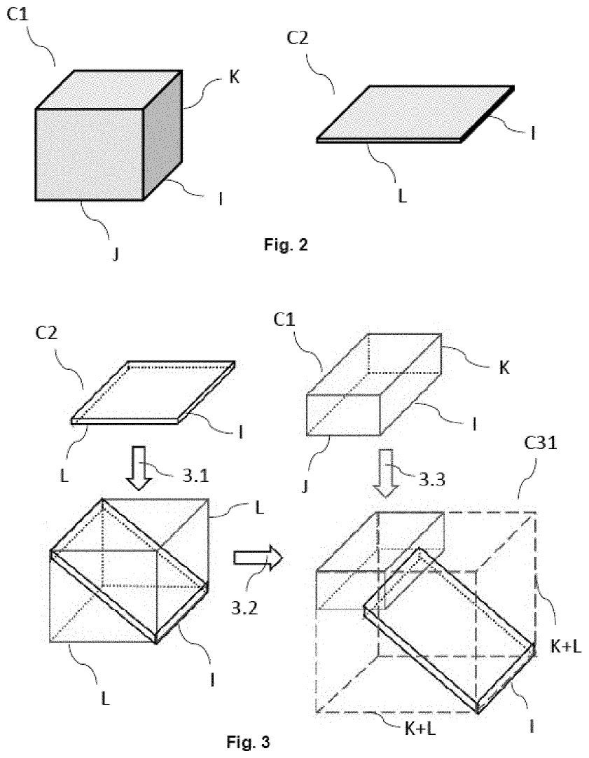

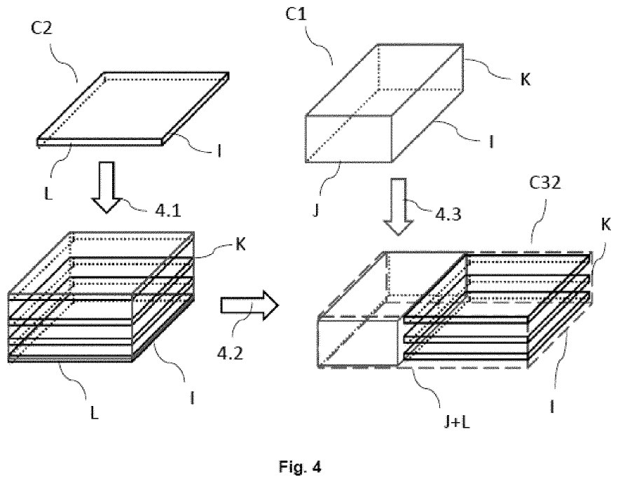

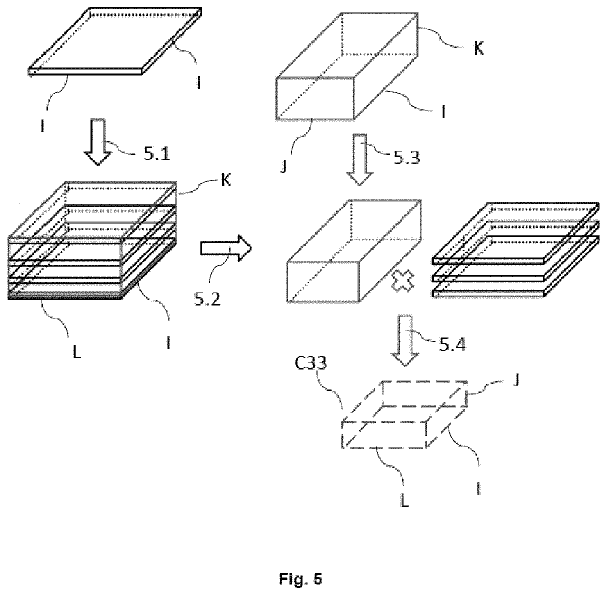

According to FIGS. 4 and 5, two other embodiments according to the invention consist of replacing the cube C2. According to step 4.1 or step 5.1, the cube C2 is replicated a number “k” of times to form an intermediary three-dimensional cube I×Lx K. Said intermediary cube I×L×K thus comprises two types of entries common with the cube C1 of dimensions I×J×K. These two three-dimensional cubes have two common modes, it is possible to combine them in several ways so as to preserve the mode I corresponding to the number “i” of samples analysed in one single and same three-dimensional cube of amalgamated data.

As illustrated in FIG. 4, a first possibility consists of proceeding according to steps 4.2 and 4.3, to juxtapose the intermediary cube IxL×K with the cube C1. By aligning the modes J and L of these two three-dimensional cubes, a three-dimensional cube C32, Ix K×(J+L), is obtained, containing all the fluorescence and absorption data.

As illustrated in FIG. 5, another possibility consists of proceeding according to steps 5.2 and 5.3, to juxtapose the intermediary cube I×L×K with the cube C1. By aligning these two cubes according to the common mode K, a three-dimensional cube C3, lx Lx J, is obtained, containing all the fluorescence and absorption data. This can be done, for example, by making a number “k” of matrix products.

It will be understood that other amalgamation modes can also be used to form a three-dimensional amalgamated data cube and to be characterised by similar technical advantages.

It will be noted, that according to the invention, organising the spectroscopic data acquired can be preceded by different pre-processing sub-steps. Advantageously, fluorescence spectrums can, for example, be pre-processed to consider the contributions due to elastic diffusion, also referred to as Rayleigh diffusion. These contributions can be calculated by means of generalised linear models, then subtracted from the spectrum(s) acquired. The subtraction of the Rayleigh diffusion is generally necessary in most analysis methods, and can be applied as part of the method of the present invention. However, subtracting the diffusion is not necessarily desirable in the present invention. In addition, the contributions of the elastic diffusion can be removed by means of a mathematical processing, in order to utilise “pure” fluorescence spectrums. Alternatively, the elastic diffusion intensities can be added for a later use, for example, during the calculation of indicators characterising the sample. The initial elastic diffusion intensities corresponding to the different excitation wavelengths can indeed be reused in combination with the information coming from the following steps of the method.

Advantageously, the spectrums acquired can be pre-processed by making an MSC (Multiplicative Scatter Correction), or an SNV (Standard Normal Variate). Advantageously, the pre-processing defined can also be applied to the data cubes according to the invention.

A seventh step g) of a method according to the invention comprises the decomposition of amalgamated data from the third cube by application of a multiway statistical model. The decomposition of data can proceed according to different types of chemometric processing. According to the size and the dimensions of the data cubes to be decomposed, the multivariate methods will thus be distinguished from the multiway methods. The multivariate methods such as PLS or PCA are, typically, methods for reducing data adapted for organised data according to two-dimensional cubes. They conventionally involve a prior folding of the initial cube according to one of the dimensions, a concatenation of the data obtained, then the analysis, per se. The multiway methods such as Tucker, NPLS, or mPCA, are methods for reducing data adapted for data organised into cubes having more than two dimensions. They are therefore intrinsically multidimensional and can be used directly on the data cubes resulting from the analysis method according to the steps defined above.

Other than the greater software effectiveness of the analysis methods permitted by the application of a multiway statistical model to one single cube of amalgamated data, rather than two data cubes, the possibility of decomposing said data, while preserving the intrinsic correlations also enables to deduce from them, more precise information about the sample(s) analysed.

The invention thus provides a quicker and more efficient analysis method. Likewise, an analysis device implementing such a method requires simpler, cheaper equipment, and consequently equipment that is best suited to industrial requirements, as it is current technologies. The invention also enables to facilitate the speed and rationalisation making decisions during the production of food products.

In an innovative way, the invention applies a new multiway decomposition technique to all the amalgamated raw data. Advantageously, multiway processing applied to achieve the decomposition of the three-dimensional cube of amalgamated data is a Tucker3 type model. The Tucker3 model enables to decompose a tensor X “I×J×K” into three two-dimensional cubes, and into two data cubes. In particular, each element x_{i,j,k} is decomposed as follows:

$${x}_{i , j , k} = {\sum }_{p = 1}^{P} {\sum }_{q = 1}^{Q} {\sum }_{r = 1}^{R} {a}_{i , p} {b}_{j , q} {c}_{k , r} {g}_{p , q , r} + {e}_{i , j , k}$$

with
a_{i,p}, b_{j,q}, c_{k,r} the elements of the respective matrices A “I×P”, B “J×Q” and C “K×R”
e_{i,j,k} is an element of the residue cube E “I×J×K”
g_{p,q,r} is an element of the interaction cube G “P×Q×R”, also called “core-array”

In any case, one of the matrices A, B or C is a matrix referred to as a “score” matrix or reduced data, whereas the others are called “loading” matrices. If, for example, the mode I is that of the samples, the matrix A “I×P” will thus be the “score” matrix, said “score” matrix” enabling to define each sample “i”, by a number “p” of representative “scores”. Said “scores” are subsequently used in the invention. The loading matrices B and C themselves represent respectively the contributions of modes J and K, whereas the cube G represents the interactions between the 3 modes.

Preferably, but in a non-limitative way, the invention can also apply a multiway decomposition of Tucker2 or PARAFAC type, these two models constituting the specific cases of Tucker3.

An eighth step h) of a method according to the invention comprises the determination of at least one indicator characterising said or each sample, from the data coming from applying said multiway statistical model to said amalgamated data. The “score” matrix coming from step g) according to the invention indeed enables to characterise the sample analysed or the samples analysed by a set of variables. Said variables can themselves be connected to said at least one indicator via a regression model. Applying said regression model on the “scores” obtained on one or more new samples thus enables to obtain the value of said indicator on these samples.

A few technical results of the invention will be defined below using two examples of application. These two examples show the improvement of the performances of predicting the characteristics of a sample using a method according to the invention, regarding the performances obtained without implementing said method.

The first example relates to the result obtained by a multilinear combination of the scores obtained via the combined analysis of the fluorescence spectrums and the fluorescence spectrums to obtain the prediction of a protein ratio in the wheat samples, for example, gluten.

For this first example, analysing 20 wheat samples is considered. Each sample is illuminated by 4 light-emitting diodes, or LEDs, emitting respective light beams at 280 nm, 340 nm, 385 nm and 450 nm. The illumination by these light beams leads to the acquisition of a full emission spectrum over an electromagnetic spectrum range extending from 250 nm to 800 nm and comprising fluorescence spectrums associated with the 20 wheat samples. Each sample is then illuminated by a halogen/tungsten lamp emitting a continuous beam spreading out over a spectral range going from 800 nm to 2500 nm. The illumination by this beam leads to the acquisition of a full emission spectrum over the same electromagnetic spectrum range, extending from 250 nm to 800 nm and comprising the transmittance and/or reflectance spectrum(s) of the 20 wheat samples. Processing of the spectrums acquired and then done by the signal analyser, in particular via one or more processors. In particular, fluorescence spectrums can be cleaned of the elastic diffusion, then pre-processed via a standardisation. This standardisation is, for example, of SNV type. It will be understood that the pre-processing of the spectrums can be done at any time preceding the organisation of the fluorescence spectrums and of the absorption spectrums into data cubes, according to the best way of implementing the method. After this pre-processing, the fluorescence spectrums are organised into one three-dimensional cube CF1, referred to as first acquisition data cube, the number of entries associated with said dimensions corresponding respectively to the number of samples, to the number of excitation beams and to the number of emission beams acquired, that is a cube of modes “Samples×Excitations×Emissions». For the example considered, the cube CF1 comprises 20×4×550, that is 44,000 entries. The absorption spectrums, possibly pre-processed using an SNV (Standard Normal Variate) standardisation, are organised into one two-dimensional cube CA0, referred to a second acquisition data cube, the number of entries associated with said dimensions corresponding respectively to the number of samples and to the number of emissions, that is a cube of modes “Samples×Emissions». For the example considered, said cube CA0 comprises 20×1,700 entries, that is 34,000 entries. The cube CA0 is then duplicated 4 times to form a cube CA1 of size 20×4×1,700, in other words, constituted of 136,000 entries.

For the present application, said cubes CF1 and CA1 are then paired according to the emission mode to obtain a cube CFA1 of modes Samples×Excitations×Emissions, of size 20×4×2,250. The cube CFA1 is then decomposed by applying an algorithm, for example, of Tucker2 type, to obtain a score matrix of size 20×15, in other words, resulting in obtaining 15 score factors for each one of the 20 samples. The score matrix is then correlated at a vector of size 20×1, said vector containing the analysis results of the gluten ratios (as a percentage) measured in each one of the samples, obtained via a multiple linear regression.

Applying these specific organisation modes enables a greater amount of information to be extracted from them. This information not only comprises the quality of the calibration over a wheat quality parameter only by infrared, and the quality of the calibration obtained only by fluorescence, but also the calibration obtained by the conjunction of the scores obtained for the two technologies separately, as well as the calibration obtained by using the three-dimensional structure explained above. The statistical performances of this regression are provided in the table below.

Table 1 below shows a table characterising the performances coming from a typical method according to the current state of the art, through the value of R² and the calibration error (RMSEC and RMSECV).

TABLE 1

| R² | RMSEC | R²CV | RMSECV | N outliers | N components |
|---|---|---|---|---|---|
| 0.93 | 0.58 | 0.90 | 0.64 | 4 | 2 |

In order to characterise the technical improvement brought by this method, similar regressions have been obtained by the methods conventionally used in literature. In particular: a decomposition of the two-way table, pre-processed with absorption data through ACP, providing a score matrix MA1 of 20×5, followed by a multilinear regression is then done. Also: a decomposition of the cube CF1 pre-processed with fluorescence data through PARAFAC, providing a score matrix MF1 of 20×6, followed by a multilinear regression is then done. Then, a concatenation of the two matrices MA1 and MF1 to form a matrix MFA1 of size 20×11, followed by a multilinear regression. The performances of the regressions thus obtained are compared with the approach forming the subject of the invention to obtain the prediction of a protein ratio in each one of the wheat samples. The comparison of these performances is presented in table 2 below, demonstrating a clear improvement of the prediction performances. The respective values of R², RMSEC, R²CV and RMSECB obtained by applying the method according to the invention to analyse the spectroscopic data coming from the acquisition of the fluorescence spectrums and the transmittance spectrums of the 20 samples considered are all greater than those obtained by applying traditional methods to analyse the data coming from only the acquisition of the fluorescence spectrums or only the acquisition of the transmittance spectrums.

TABLE 2

| | | | | | | N |
|---|---|---|---|---|---|---|
| | | | | | N | compo- |
| | R² | RMSEC | R²CV | RMSECV | Outliers | nents |
| Fluorescence | 0.89 | 0.82 | 0.82 | 0.90 | 4 | 2 |
| Transmittance | 0.91 | 0.85 | 0.85 | 1.05 | 4 | 2 |
| Combination | 0.93 | 0.91 | 0.91 | 0.81 | 4 | 2 |

The second example of application, close but separate from the first example defined above, relates to the result obtained by a multilinear combination of the scores obtained via the combined analysis of the fluorescence spectrums and the fluorescence spectrums to obtain the prediction of a protein ratio in the wheat samples.

Each sample is successively illuminated by 4 LEDs emitting respective light beams at 280 nm, 340 nm, 385 nm and 450 nm. For each one of said light beams, a full emission spectrum has been acquired over the range 250 nm-800 nm. Each sample is then illuminated by a halogen/tungsten lamp over a spectral range going from 800 nm to 2,500 nm, and the corresponding absorption spectrum is acquired over the same range. Fluorescence spectrums are cleaned of the elastic diffusion, then pre-processed via an SNV (Standard Normal Variate) standardisation and organised into one first data cube CF2 of modes “Samples×Excitations×Emissions”, and of size 20×4×550. The absorption spectrums themselves are pre-processed via an SNV (Standard Normal Variate) standardisation and organised into a second data cube of modes “Samples×Emissions” of size 20×1,700. Said table of absorption data is duplicated 4 times and the 4 tables thus obtained are paired to form a new cube CA2 of size 20×4×1,700. A matrix product according to the Excitation mode is then made between the cubes CF2 and CA2, to obtain a cube CFA2 of modes “Samples×Emissions×Emissions”, of size 20×550×1,700. Then, this cube is decomposed by applying a PARAFAC algorithm, enabling the obtaining of a score matrix “Samples×Factors”, of size 20×15. The score matrix is then correlated to a vector of size 20×1 containing the results of analysing the protein ratios (%) measured in each one of the samples, via a multiple linear regression. The statistical performances of this regression are provided in table 3 below. The table below shows a table characterising the performances coming from a typical method according to the current state of the art, through the value of R² and the calibration error (RMSEC and RMSECV).

TABLE 3

| R² | RMSEC | R²CV | RMSECV | N Outliers | N components |
|---|---|---|---|---|---|
| 0.97 | 0.16 | 0.94 | 0.21 | 4 | 3 |

In order to characterise the technical improvement brought by this method, similar regressions have been obtained by methods conventionally used in literature in the current state of the art: a decomposition of the two-way table pre-processed with absorption data by ACP, providing a score matrix MA1 of 20×5, followed by a multilinear regression. Also: a decomposition of the cube CF1 pre-processed with fluorescence data by PARAFAC, providing a score matrix MF1 of 20×6. A multilinear regression is then made. Finally: a simple concatenation of the two matrices MA1 and MF1 to form a matrix MFA1 of size 20×11, followed by a multilinear regression. The performances of the regressions thus obtained are compared with the approach forming the subject of the invention, thus demonstrating an improvement of the prediction performances, as indicated in table 4 below.

TABLE 4

| | | | | | | N |
|---|---|---|---|---|---|---|
| | | | | | N | compo- |
| | R² | RMSEC | R²CV | RMSECV | Outliers | nents |
| Fluorescence | 0.62 | 0.27 | 0.40 | 0.30 | 4 | 2 |
| Transmittance | 0.87 | 0.25 | 0.85 | 0.26 | 4 | 2 |
| Combination | 0.93 | 0.21 | 0.88 | 0.23 | 4 | 3 |

To summarise, the present invention relates to an analysis method enabling to optimise the joint processing of spectral data coming from two different spectroscopic technologies to analyse one or more given samples. In particular, the analysis method defined, and the different embodiments thereof, aim to reconcile the constraints resulting from the simultaneous use of these two technologies, in particular, absorption spectroscopy and fluorescence spectroscopy. The invention thus proposes an innovative analysis method for obtaining more precise indicators characterising the quality of one or more samples. The present invention also proposes an analysis device for the implementation of such an analysis method.

Of course, to satisfy specific needs, a person skilled in the field of the invention can apply modifications in the preceding description.

Although the present invention has been defined above in reference to specific embodiments, the present invention is not limited to the specific embodiments, and the modifications which are located in the field of application of the present invention will be clear for a person skilled in the art.

1. A method for analyzing at least one sample, implementing a method for analysing spectroscopic data based on a multiway statistical model, characterised in that it comprises:
a) the illumination of said or of each sample to be analyzed by a first light source and by a second light source, said at least one second light source being separate from said first light source;
b) the acquisition of fluorescence spectrums of said or of each sample, said fluorescence spectrums resulting from the illumination of said or of each sample by one or more light beams emitted by said first light source;
c) the acquisition of transmittance and/or reflectance spectrums of said or of each sample, said transmittance and/or reflectance spectrums resulting from the illumination of said or of each sample by one or more light beams emitted by said second light source;
d) the organisation of said fluorescence spectrums acquired into a first acquisition data cube;
e) the organisation of said transmittance and/or reflectance spectrums acquired into a second acquisition data cube;
f) the amalgamation of acquisition data of said first cube and of acquisition data of said second cube into a third amalgamated data cube;
g) the decomposition of said amalgamated data of said third cube by applying said multiway statistical model; and
h) the determination of at least one indicator characterising said or each sample, from the data coming from applying said multiway statistical model to said amalgamated data.

2. The method according to claim 1, wherein said first light source is a light radiation source with respective illumination wavelengths.

3. The method according to claim 1, wherein said second light source is a continuous source.

4. The method according to claim 1, where said fluorescence spectrums are spectrums acquired over a spectral range of between 250 nm and 800 nm.

5. The method according to claim 1, wherein said transmittance and/or reflectance spectrums are spectrums acquired over a spectral range of between 400 nm and 2500 nm.

6. The method according to claim 1, wherein the number of light beams emitted by the first light source is between one and eight.

7. The method according to claim 1, wherein the fluorescence spectrums are fluorescence spectrums acquired in frontal mode.

8. The method according to claim 1, wherein said step d) also comprises a prior step of standardising said fluorescence spectrums and/or said transmittance and/or reflectance spectrums.

9. The method according to claim 1, wherein said multiway statistical model implemented is a Tucker type model.

10. The method according to claim 1, wherein said determination of an indicator characterising said or each sample is done by applying a calibration model connecting the decomposition data to said indicator.

11. A device for analysing at least one sample for the implementation of a method according to claim 1, characterised in that it comprises:
means for illuminating said or each sample to be analysed, said illumination means comprising a first light source and at least one second light source, said at least one second light source being separate from said first light source;
a first means for acquiring fluorescence spectrums of said or of each sample, said fluorescence spectrums resulting from said or from each sample by one or more light beams emitted by said first light source;
a second means for acquiring transmittance and/or reflectance spectrums from said or from each sample, said transmittance and/or reflectance spectrums resulting from the illumination of said or of each sample by one or more light beams emitted by said second light source; and
one or more processors configured to implement at least steps d) to h).
